(19) United States
(12) Patent Application Publication
(10) Pub. No.: US 2008/0000341 A1
(43) Pub. Date: Jan. 3, 2008

(54) Saw blade with a lateral run-out

(76) Inventors: Christoph Weber, Neuheim (CH); Claudia Kowanda, Luzern (CH)

Correspondence Address: ABELMAN, FRAYNE & SCHWAB, 666 THIRD AVENUE, 10TH FLOOR, NEW YORK, NY, 10017, US

(21) Appl. No.: 11/818,001

(22) Filed: Jun. 12, 2007

(30) Foreign Application Priority Data
Jun. 14, 2006 (DE) 10 2006 000 297.0

(51) Int. Cl. B23D 61/02

(52) U.S. Cl. 83/846; 83/678

(57) ABSTRACT

A circular saw blade (2) includes at least two sectors (S) following each other in a circumferential direction and each having an axial run-out region (B1, B2), with the following each other axial run-out regions (B1, B2) directed to opposite sides of the blade saw (2) relative to a saw middle plane (E), and a working element (6), preferably a diamond body, provided on a circumference (U) of the saw blade.

### BACKGROUND OF THE INVENTION

1. Field of the Invention

The present invention relates to a circular saw blade, in particular for working natural or artificial stone materials, e.g., in form of concrete walls.

2. Description of the Prior Art

A saw blade of a type, which is discussed above, has, on its circumference, working means such as cutting or grinding means, or a combination thereof. The cutting or grinding means can be formed, e.g., by a diamond body, cutting teeth, or a combination of both.

The saw blade of the above-described type has a central bore which provides for mounting of the saw blade on a tool holder of a corresponding power tool which rotationally drives the saw blade during an operation.

European Patent Publication EP 1 270 126 A1 discloses a circular saw blade with a support disc on a circumference of which cutting elements are provided. On the side surfaces of the support disc, particular wear-resistant regions are provided. These regions prevent an excessive heating, which can be caused by friction, and a resulting deformation of the saw blade, which can lead to a non-precise cut.

The drawback of the known saw blades consists in relatively high costs of material.

Accordingly, an object of the present invention is to provide a saw blade in which the foregoing drawbacks of the known saw blade are eliminated. Another object of the present invention is to provide a saw blade which would insure a precise cut at low cots of its manufacturing.

### SUMMARY OF THE INVENTION

This and other objects of the present invention, which will become apparent hereinafter, are achieved by providing a saw blade having at least two sectors following each other in a circumferential direction and each having an axial run-out region, with the following each other axial run-out regions being directed to opposite sides of the blade saw relative to a saw middle plane.

The alternatively arranged one after another, in the circumferential direction, axial run-out regions and/or transitional regions provided therebetween, provide a certain stiffening of the saw blade in the axial direction. Thereby, the saw blade has an increased lateral stability during an operation, which insures a particularly precise cut. Further, the axial run-out regions produce a certain ventilation effect which provides for a better cooling of the saw blade during an operation. However, in case of a prolonged operation, reduction of stiffness due to the heating of the saw blade can take place.

It is advantageous when at a diameter of the saw blade of less than 800 mm, the saw blade comprises four sectors having alternating axial run-out regions with a maximum axial run-out between 0.1 and 0.2 mm, and where at a diameter of the saw blade of more than 800 mm, the saw blade comprises six sectors having alternating axial run-out regions with a maximum axial run-out between 0.2 and 0.4 mm.

Thereby, the maximal run-out of the saw blade lies within conventional tolerances for the corresponding size of the saw blade, so that no noticeable increase of a respective cut width and no noticeable drop of the cutting speed take place. At the same time, the lateral stability of the saw blade and the resulting precision of the cut are noticeably increased at a given minimal number of the axial run-out regions by the formed transition regions between the alternating maximal runs-out.

Advantageously, between the maximal axial runs-out of the two respective adjacent sectors, there is provided a transition region in which the saw blade circumference has a monotone inclination relative to the middle plane and which extends in the circumferential direction over at least 30°. Such transition regions provide a particularly good stiffening of the saw blade in the axial direction.

Advantageously, the circumference of the saw blade has a continuous wave shape whereby, despite the formed runs-outs, during an operation, a quite run of the saw blade in a cut material is achieved.

Advantageously, the axial run-out regions are formed by imparting correspondingly directed blows to the side surfaces of the saw blade. In this way, a particular simple and economical production of saw blades becomes possible.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a plan view of a saw blade according to the present invention with four sectors;

FIG. 2 an exaggerated side view of the inventive saw blade in direction II in FIG. 1 without working means;

FIG. 3 a plan view of a saw blade according to the present invention with six sectors; and

FIG. 4 an exaggerated side view of the inventive saw blade in direction IV in FIG. 3 without working means.

### DETAILED DESCRIPTION OF THE PREFERRED EMBODIMENTS

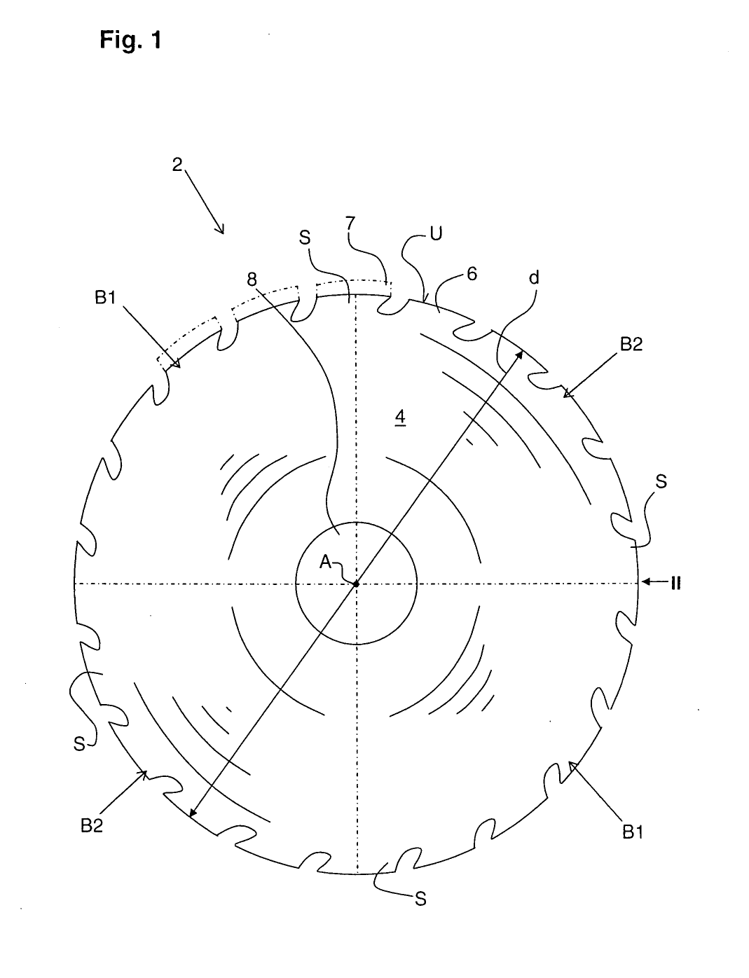

FIG. 1 shows a saw blade 2 for working mineral material formed as a wall saw blade with a diameter d of up to 800 mm. The saw blade 2 has a blade body, e.g., of steel, on which working means 6 in form of cutting teeth are provided. The cutting teeth can be formed integrally with the blade body 4 or be formed at least partially of a special material deposited onto the blade body 4. Alternatively, instead of the cutting teeth or in combination therewith, a diamond body can be provided on a circumference U of the saw blade 2 as shown in FIG. 1 with dash-dot lines, with diamond segments 7 mounted over the circumference U of the saw blade 2.

For securing the saw blade 2 on a tool holder of a power tool that rotationally drives the saw blade 2 about an axis A in a circumferential direction, it is provided with a central bore 8. The saw blade 2 is divided in four equally large sectors S, with the sectors having, in the circumferential direction, alternating left axial run-out region B1 and right axial run-out region B2.

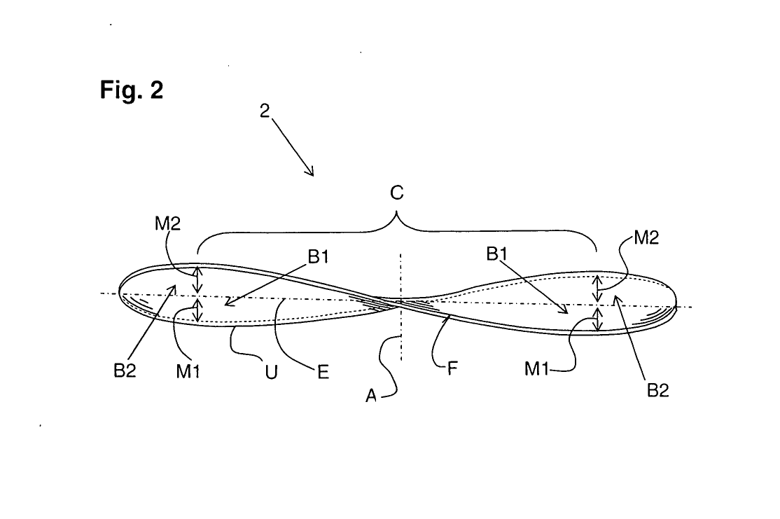

In FIG. 2, for an easier understanding, the saw blade 2 is shown with exaggerated axial run-out regions B1 and B2 and without working means 6.

As can be seen, the axial run-out regions B1 and B2 extend away form a middle plane E that extends perpendicular to the axis A. All of the axial run-out regions B1 and B2 form a maximal lateral run-out M1, M2 that amounts, from the center of a circumferential surface F of the circumference U to the middle plane E between 0.1 and 0.2 mm, preferably, 0.125 mm.

As further shown in FIG. 2, the saw blade 2 forms, on the circumference U between two maximal run-outs M1, M2 of two adjacent sectors, respective transition regions C which extend over 90° and which have, with respect to the middle plane E, a wave-shaped monotonous inclination.

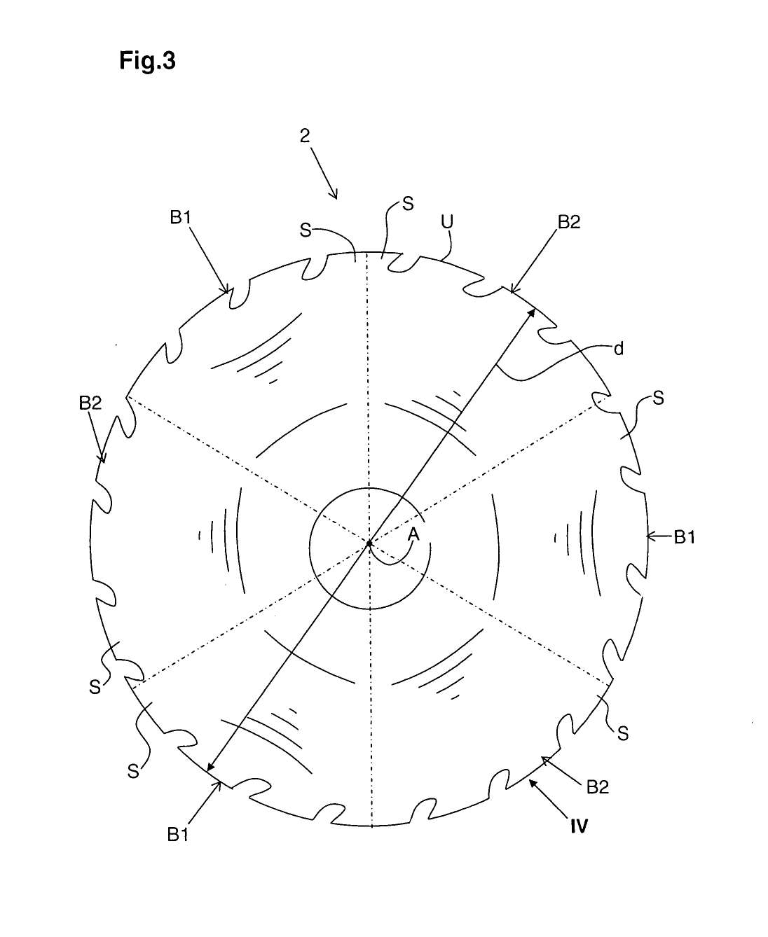

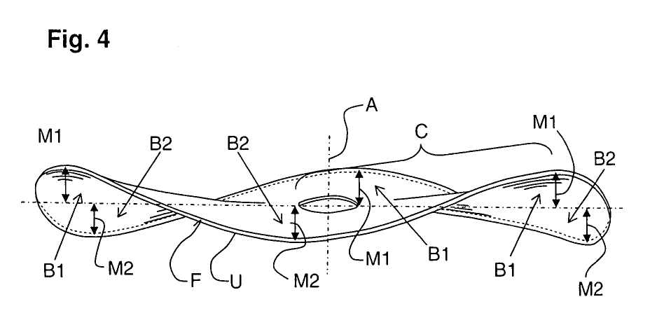

FIGS. 3 and 4 saw the saw blade 2 in form of a wall saw blade with a diameter of more than 800 mm. Contrary to the embodiment according to FIGS. 1 and 2, here, there are provided six sectors S with axial run-out regions B1 and B2. All of the axial run-out regions have a maximal run-out M1, M2 that amounts to between 0.2 to 0.45 mm, in particular to 0.3 mm (FIG. 4).

As shown in FIG. 4, in this embodiment, the blade 2 forms, on the circumference U between the maximal deviations M1, M2, two adjacent sectors, respective transition regions C which extend over 60° and which have, with respect to the middle plane E, a wave-shaped monotonous inclination.

The manufacturing of the axial run-out regions B1, B2 is effected by correspondingly imparting to the saw blade 2, blows in the director of axis A with a tool, not shown, with the blows being applied in a predetermined number and a predetermined blow energy.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A circular saw blade (2), comprising at least two sectors (S) following each other in a circumferential direction and each having an axial run-out region (B1, B2), the following each other axial run-out regions (B1, B2) being directed to opposite sides of the blade saw (2) relative to a saw middle plane (E); and working means (6) provided on a circumference (U) of the saw blade.

2. A circular saw blade according to claim 1, wherein the working means (6) comprises a diamond body.

3. A circular saw blade according to claim 1, wherein at a diameter (d) of the saw blade (2) of less than 800 mm, the saw blade comprises four sectors (S) having alternating axial run-out regions (B1, B2) with a maximum axial run-out (M1, M2) between 0.1 and 0.2 mm.

4. A circular saw blade according to claim 1, wherein at a diameter (d) of the saw blade (2) of more than 800 mm, the saw blade comprises six sectors (S) having alternating axial run-out regions with a maximum axial run-out (M1, M2) between 0.2 and 0.45 mm.

5. A circular saw blade according to claim 3, wherein between the maximal axial run-outs (M₁ M₂) of two respective adjacent sectors (S), there is provided a transition region (C) in which the saw blade circumference (U) has a monotone inclination relative to the middle plane (E) and which extends in the circumferential direction over at least 30°.

6. A circular saw blade according to claim 4, wherein between the maximal axial run-outs (M₁ M₂) of two respective adjacent sectors (S), there is provided a transition region (C) in which the saw blade circumference (U) has a monotone inclination relative to the middle plane (E) and which extends in the circumferential direction over at least 30°.

7. A circular saw blade according to claim 5, wherein the saw blade circumference (U) has a continuous wave shape.

8. A circular saw blade according to claim 6, wherein the saw blade circumference (U) has a continuous wave shape.

9. A circular saw blade according to claim 1, wherein the axial run-out regions (B1, B2) are formed by imparting correspondingly directed blows to the side surfaces of the saw blade (2).
